(19) United States
(12) Patent Application Publication
(10) Pub. No.: US 2017/0067806 A1
(43) Pub. Date: Mar. 9, 2017

(54) Automatic Stool Sampling Device With End-To-End No-Glove Or Manual Handling

(71) Applicant: Rajan Dewar, Northborough, MA (US)

(72) Inventor: Rajan Dewar, Northborough, MA (US)

(21) Appl. No.: 15/246,937

(22) Filed: Aug. 25, 2016

Related U.S. Application Data
(60) Provisional application No. 62/214,434, filed on Sep. 4, 2015.

(51) Int. Cl. G01N 1/38; G01N 1/14

(52) U.S. Cl. CPC G01N 1/38; G01N 1/14

(57) ABSTRACT

An automated stool sampling device includes a pump that liquefies a stool and a syringe that deposits a sample of the liquefied stool into a sample tube. The sample tube has a self-sealing plug. The syringe is retracted from the sample tube after that sample has been collected. Saline may be introduced via a valve and saline reservoir. Detergent may be introduced via a valve and detergent reservoir. Valves may connect the system to a waste receptacle and waste treatment plumbing so that feces may be either sampled or sent directly to waste treatment. A computer program controls the pump and valves in order to automate sample collection and system flushing.

### CROSS-REFERENCE TO RELATED APPLICATIONS

This application claims priority to U.S. provisional patent application 62/214,434, entitled AUTOMATIC STOOL SAMPLING DEVICE WITH END-TO-END NO-GLOVE OR MANUAL HANDLING, filed Sep. 4, 2015, which is incorporated by reference.

### BACKGROUND

Human feces are the solid waste products of the human digestive system, including bacteria. They vary significantly in appearance (i.e. size, color, texture), according to the state of the digestive system, diet and general health. Normally a stool is semisolid, with a mucus coating.

On average humans excrete 128 grams of fresh feces per person per day with a pH value of around 6.6. Fresh feces contain around 75% water and the remaining solid fraction is 84-93% organic solids. These organic solids consist of: 25-54% bacterial biomass, 2-25% protein or nitrogenous matter, 25% carbohydrate or undigested plant matter and 2-15% undigested fat. These proportions vary considerably depending on many factors such as mainly diet and body weight. The remaining non-organic solids are composed of calcium and iron phosphates, intestinal secretions, small amounts of dried epithelial cells, and mucus.

### SUMMARY

All examples, aspects and features mentioned in this document can be combined in any technically possible way. Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” or “an” to modify a noun may be understood to be used for convenience and to include one, or more than one of the modified noun, unless otherwise specifically stated.

In accordance with an aspect an automatic stool handling device comprises: a pump that liquefies a stool passing there through, thereby providing a liquefied stool; a sample discharge conduit that establishes a hydraulic pathway into a sample collection container, the liquefied stool from the pump traversing the hydraulic pathway and being deposited into the sample collection container; and a flushing system. In some implementations the discharge conduit comprises a syringe. In some implementations the sample collection container comprises a sample tube with a self-sealing plug. In some implementations a first valve control flow through the sample discharge conduit. In some implementations the flushing system comprises a detergent reservoir. In some implementations the apparatus comprises a saline reservoir. In some implementations a computer program stored on a non-transitory computer-readable medium that is run by a processor actuates the pump and the first valve to collect a stool sample and flush the device.

In accordance with an aspect a method comprises: in a system comprising a pump and a sample discharge conduit connected to the pump via a first valve: preparing a sample collection container by inserting the sample discharge conduit into the sample collection container; actuating the pump to liquefy a stool, thereby creating a liquefied stool; actuating the first valve to cause the liquefied stool to flow into the sample collection container via the sample discharge conduit; actuating the first valve to terminate flow into the sample collection container; and flushing the system. In some implementations preparing the sample collection container comprises inserting a syringe connected to the first valve into a sample tube having a self-sealing plug. In some implementations the first valve is closed after a predetermined amount of the liquefied stool has been deposited in the sample tube. In some implementations the syringe is retracted from the sample tube after closing the first valve. In some implementations saline is mixed with the stool. In some implementations flushing the system comprises pumping detergent through the system.

### BRIEF DESCRIPTION OF THE DRAWINGS

FIG. 1 illustrates an automatic stool handling apparatus.

FIG. 2 illustrates an automatic stool handling process.

### DETAILED DESCRIPTION

The detailed description set forth below will enable those of ordinary skill in the art to practice the invention. Upon reading the detailed description in light of the accompanying figures, those of ordinary skill in the art will understand the concepts of the invention and recognize further variations and implementations of these concepts. It should be understood that these further variations and implementations fall within the scope of the disclosure.

Some aspects, features and implementations described herein may include machines such as computer devices, electronic components, optical components, and processes such as computer-implemented steps. It will be apparent to those of ordinary skill in the art that the computer-implemented steps may be stored as computer-executable instructions on a non-transitory computer-readable medium. Furthermore, it will be understood by those of ordinary skill in the art that the computer-executable instructions may be executed on a variety of tangible processor devices. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

Many medical issues are diagnosed by examining biological specimen from the body, such as peripheral blood, urine or other body fluids (pleural, pericardial). A common specimen that is not extensively or commonly utilized for such diagnosis is a stool sample. A major barrier for utilizing stool for medical laboratory diagnosis or personal monitoring of health is that handling a stool sample is considered unhygienic and esthetically unpleasant.

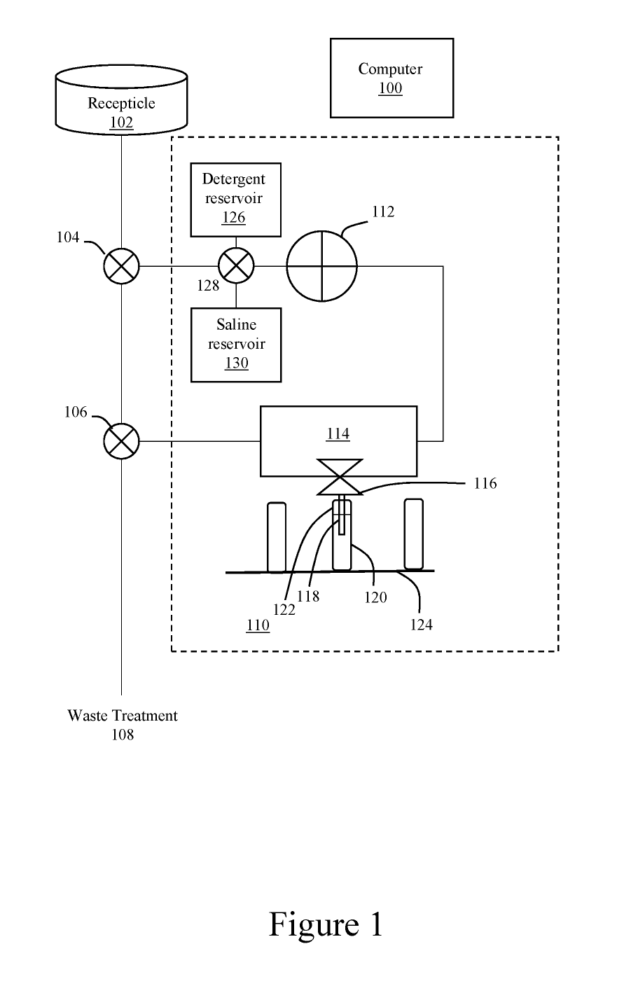

FIG. 1 illustrates an automatic stool handling device. The device automatically provides stool samples that are ready for transport and analysis. A collected stool is liquefied, homogenized, and a sample thereof is deposited into a sample tube. Advantageously, one or more of collection, liquefaction, homogenization, and capture in a sample tube may be performed without any need for manual handling of stool. The device may be automated under control of a computer 100 that runs a computer program that controls various system elements.

In the illustrated example the automatic stool handling device includes a receptacle 102 via which the stool is initially captured. The receptacle 102 could include, for example and without limitation, a modified or standard toilet. The hydraulic outlet of the receptacle 102 is connected to a diverter valve 104. Diverter valve 104 is connected to another diverter valve 106. The diverter valves 104, 106 have three ports but connect only two ports in each of multiple setting positions. Diverter valve 104 has two position settings that respectively cause stool captured in the receptacle 102 to be directed either to waste treatment 108 or to a sampling subsystem 110. By setting both diverter valves in a pass-through position the stool from receptacle 102 directed to waste treatment 108 directly, i.e. bypassing subsystem 110. By setting both diverter valves in a diverting position flow is directed to waste treatment via the subsystem 110. In a test mode the diverter valves are actuated to direct the stool into a sample tube. The diverter valves may then be adjusted to flush the subsystem before being returned to the pass-through position.

Sampling subsystem 110 includes a pump 112 and a container 114. The pump 112 assists stool intake, sampling, discharge, and subsystem flushing. The pump 112 liquefies and homogenizes the stool as it traverses the pump. The pump 112 may include a commercial grade drain pump or macerator pump. One type of drain pump is a Saniflo Residential SANISHOWER. The pump 112 directs the liquefied and homogenized stool to the container 114. The container may include a distinct vessel or be a portion of the hydraulic conduit between pump 112 and diverter valve 106. One example of a container is a vacutainer. The container 114 is fitted with a sample collection valve 116. The valve 116 is connected to a fluid conduit 118 such as a syringe. The conduit establishes a hydraulic pathway between the container 114 and a sample tube 120. Because the stool in the container is under pressure from the pump 112, a volume of the stool flows into the sample tube. The sample tube 120 may include a self-sealing plug 122 at a distal end. The self-sealing plug 122 can be pierced by the syringe in order to deposit the stool sample into the sample tube. The plug self-seals when the syringe is retracted from the sample tube. Insertion and retraction of the syringe relative to the sample tube may be automated with electric motors. Moreover, multiple sample tubes may be mounted in a motorized carousel 124 such that multiple samples can be automatically collected.

The automatic stool handling device may include a detergent based purging system to clean the subsystem 110 after and/or before entering test mode, e.g. in order to prevent run-to-run carry over effects. A detergent reservoir 126 is connected to a multi-way diverter valve 128 (or a separate detergent reservoir valve) such that detergent fluid can be drawn from the reservoir by the pump 112. The pump causes the detergent to flow through the container 114 and to waste treatment 108 via valve 106.

The automatic stool handling device may include a saline flush system that obtains samples in isotonic saline to preserve biological sample, when appropriate. A saline reservoir 130 is connected to a multi-way diverter valve 128 such that saline fluid can be drawn from the reservoir, e.g. along with stool from receptacle 102, by the pump 112. The pump causes the saline and stool to flow into the container 114.

The automatic stool handling device has downstream applications including personal diagnostics; point of care (fecal fat, protein); and weight loss. The automatic stool handling device also is useful by way of an App for enhanced personalized daily monitoring of health, for Genomics—GI Microbiome; and for cancer screening—(e.g., colorectal cancer).

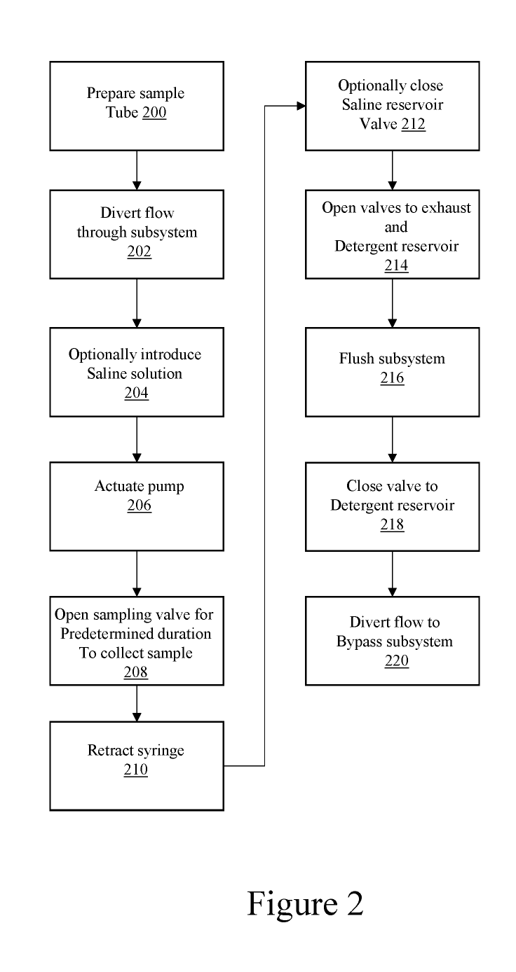

FIG. 2 illustrates a method of providing stool samples. Steps of the method may be implemented by a computer program that is stored on a non-transitory computer-readable medium of computer 100 (FIG. 1) and run by tangible processors therein. Initially the diverter valves may be set in the pass-through position to direct fecal matter directly from the receptacle to waste treatment. As indicated in block 200, an initial step in performing a test is to prepare a sample tube. The carousel, under control of the computer program, rotates a sample tube into position relative to the syringe. The electric motors are then actuated to cause the syringe to pierce the self-sealing plug of the sample tube and insert the syringe into the sample tube. As indicated in block 202, the diverter valve (104, FIG. 1) is then actuated to direct flow from the receptacle into the subsystem. Optionally, the saline reservoir valve may be actuated to allow saline solution from the saline reservoir to mix with the stool as indicated in block 204. As indicated in block 206, the pump is actuated. The pump liquefies and homogenizes the stool (and saline, if introduced) and deposits the resulting liquid into the container. As indicated at block 208, the program actuates the sample collection valve that establishes a hydraulic pathway between the container and the sample tube via the syringe, e.g. for a predetermined amount of time. The stool sample is thus deposited into the sample tube under pump pressure. Once the sampling valve has closed the syringe is withdrawn from the sample tube as indicated in block 210. The saline reservoir valve is then closed, if saline was introduced, as indicated in block 212. The exhaust side diverter valve (106, FIG. 1) and the detergent reservoir valve (128, FIG. 1) are then opened as indicated in block 214. Detergent is then pumped through the subsystem, e.g. for a predetermined period of time and at a predetermined rate of flow, such that the subsystem is flushed as indicated in block 216. Pumping is then stopped and the detergent reservoir valve is closed as indicated in block 218. The diverter valves (104, 106, FIG. 1) are then returned to their original pass-through positions as indicated in block 220, thereby bypassing the subsystem.

It should be understood that the process steps described above could be implemented in any combination, any number of time, and in any order. For example, detergent flushing could be performed immediately before, following, or before and following stool sample collection.

A number of features, aspects, embodiments and implementations have been described. Nevertheless, it will be understood that a wide variety of modifications and combinations may be made without departing from the scope of the inventive concepts described herein. Accordingly, those modifications and combinations are within the scope of the following claims.

What is claimed is:

1. An automatic stool handling device comprising:
a pump that liquefies a stool passing there through, thereby providing a liquefied stool;
a sample discharge conduit that establishes a hydraulic pathway into a sample collection container, the liquefied stool from the pump traversing the hydraulic pathway and being deposited into the sample collection container; and
a flushing system.

2. The apparatus of claim 1 wherein the discharge conduit comprises a syringe.

3. The apparatus of claim 2 wherein the sample collection container comprises a sample tube with a self-sealing plug.

4. The apparatus of claim 1 further comprising a first valve that controls flow through the sample discharge conduit.

5. The apparatus of claim 1 wherein the flushing system comprises a detergent reservoir.

6. The apparatus of claim 1 further comprising a saline reservoir.

7. The apparatus of claim 4 comprising a computer program stored on a non-transitory computer-readable medium that is run by a processor to actuate the pump and the first valve to collect a stool sample and flush the device.

8. A method comprising:
in a system comprising a pump and a sample discharge conduit connected to the pump via a first valve:
preparing a sample collection container by inserting the sample discharge conduit into the sample collection container;
actuating the pump to liquefy a stool, thereby creating a liquefied stool;
actuating the first valve to cause the liquefied stool to flow into the sample collection container via the sample discharge conduit;
actuating the first valve to terminate flow into the sample collection container; and
flushing the system.

9. The method of claim 8 wherein preparing the sample collection container comprises inserting a syringe connected to the first valve into a sample tube having a self-sealing plug.

10. The method of claim 9 comprising closing the first valve after a predetermined amount of the liquefied stool has been deposited in the sample tube.

11. The method of claim 10 comprising retracting the syringe from the sample tube after closing the first valve.

12. The method of claim 8 comprising mixing saline with the stool.

13. The method of claim 8 wherein flushing the system comprises pumping detergent through the system.
